(19) United States
(12) Patent Application Publication
(10) Pub. No.: US 2015/0185740 A1
(43) Pub. Date: Jul. 2, 2015

(54) Thermostat with two set temperatures

(71) Applicant: Alexander Kingson, Northridge, CA (US)

(72) Inventor: Alexander Kingson, Northridge, CA (US)

(21) Appl. No.: 14/057,604

(22) Filed: Dec. 26, 2013

(51) Int. Cl. G05D 23/19

(52) U.S. Cl. CPC G05D 23/19

(57) ABSTRACT

It is shown that it is possible to add an additional regulating temperature to a conventional thermostat which allows having two boundary points. This second temperature allows significantly reduce energy consumption by delaying start times of the object connected to this thermostat.

This new thermostat has two temperatures to set. One serves for upper limit the other for lower limit.

If set to heat and room temperature is between these two limits, thermostat is closed. When temperature goes down and passes the lower limit, then it opens and remains open until temperature goes up and equals the upper limit.

If set to cool and room temperature is between these two limits, thermostat is closed. When temperature goes above the upper limit, then it opens and remains open until temperature goes down and equals the lower limit.

As an example let us consider the case with heat and choose upper level as 86F and lower level as 74F. With these set temperatures this new thermostat will open heat if room temperature is less than 74F and keep heater functioning until temperature reaches 86F. Then it waits until temperature drops under 74F and cycle repeats.

As it is seen, the heater waits during temperature change from 86F to 74F which may take considerable time depending on the heat exchange versus to the case with one temperature thermostat when it starts and stops frequently leading to waste of energy and annoying noise.

1. Addition of a second regulating temperature to a conventional thermostat. One serves for upper limit the other for lower limit.

2. If set to heat and room temperature is between these two limits, thermostat is closed. When temperature goes down and passes the lower limit, then it opens and remains open until temperature goes up and equals the upper limit.

3. If set to cool and room temperature is between these two limits, thermostat is closed. When temperature goes above the upper limit, then it opens and remains open until temperature goes down and equals the lower limit.

6. Addition of a second regulating temperature to a conventional thermostat. One serves for upper limit the other for lower limit.

7. If set to heat and room temperature is between these two limits, thermostat is closed. When temperature goes down and passes the lower limit, then it opens and remains open until temperature goes up and equals the upper limit.

8. If set to cool and room temperature is between these two limits, thermostat is closed. When temperature goes above the upper limit, then it opens and remains open until temperature goes down and equals the lower limit.
